(19) United States
(12) Patent Application Publication
(10) Pub. No.: US 2013/0319268 A1
(43) Pub. Date: Dec. 5, 2013

(54) SCREEN PRINTING APPARATUS

(71) Applicant: Glassline Corporation, Perrysburg, OH (US)

(72) Inventors: Chuck Gottschalk, Whitehouse, OH (US); Dave Downard, Rossford, OH (US); Matthew Crots, Riga, MI (US)

(21) Appl. No.: 13/910,536

(22) Filed: Jun. 5, 2013

Related U.S. Application Data
(60) Provisional application No. 61/655,760, filed on Jun. 5, 2012.

(51) Int. Cl. B41F 15/08

(52) U.S. Cl. CPC B41F 15/0804
USPC 101/126; 101/129

(57) ABSTRACT

A screen printing apparatus includes a substrate for receiving a sheet of material thereon and a support frame releasably coupled to a master frame for securing a print screen. The print screen configured to impart an imprint on the sheet of material. The screen printing apparatus further includes a plurality of uprights coupled to the support frame and a plurality of servomechanisms coupled to the plurality of uprights and configured to contact the support frame to selectively position the print screen in respect of the substrate.

This application claims priority to U.S. Provisional Patent Application Ser. No. 61/655,760 filed Jun. 5, 2012, hereby incorporated herein by reference in its entirety.

### FIELD OF THE INVENTION

The invention relates to an apparatus for screen printing on a sheet of material, and more particularly to a screen printing apparatus including a print screen configured to impart an imprint on the sheet of material, and at least one servomechanism to selectively position the print screen.

### BACKGROUND OF THE INVENTION

The known types of apparatuses for screen-printing on a sheet of material generally include a fixed structure connected to an underlying substrate on which the sheet of material to be printed is positioned by means of extraction from a feeding station. Linked to the fixed structure is a support frame. The support frame is coupled to a master frame which supports a print screen, and rails to guide and move a printing bridge. The printing bridge further includes an ink applicator mechanism having a flood bar and a squeegee bar attached thereto. The printing cycle involves a variable separation of the underlying substrate from the print screen during different phases of the printing cycle. During an entrance and an exit of the sheet of material, the underlying substrate is separated from the print screen to create a sufficient distance therebetween to facilitate receiving the sheet of material onto the apparatus and transferring of the sheet of material from the apparatus. At the start of the printing cycle, the underlying substrate and the print screen must be set to a distance which is a sufficient distance therebetween for printing on the sheet of material. Additionally, a variable distance between the underlying substrate and print screen may be necessitated during a travel of the squeegee bar during the printing cycle. In certain cases, separation of the underlying substrate from the print screen may be desirable for an extraction and cleaning of the print screen.

Currently, multiple mechanical systems are required for the variable separation of the underlying substrate from the print screen during the different phases of the printing cycle described hereinabove. Certain mechanical systems used for the screen printing apparatus include the use of gear motors, cams, and cylinders which add complexity to the operation. Because the mechanical systems are complex, precision and quality is difficult to control.

In certain screen printing apparatuses, the support frame and the master frame are hinged together in correspondence with an exit side of the printed sheet of material. In other screen printing apparatuses, the movement between the support frame and the master frame occurs along a direction perpendicular to a plane of the sheet of material. To carry out such movements, it is known to use sliders that run along suitably shaped guides, or cam disks of the cam nose type to impart the desired movement during each printing cycle, The principal drawbacks of the known apparatuses are due, in particular, to the fact that the systems for the movement of the support frame and the master frame are particularly complex and subject to wear. As a result, frequent adjustment operations, necessary to compensate for the wear, require particularly long intervention time and apparatus downtimes.

It would be desirable to produce a screen printing apparatus which has a simple design, yet maximizes efficiency by minimizing adjustment interruptions and downtime and maximizes printing precision and quality.

### SUMMARY OF THE INVENTION

In concordance and agreement with the present invention, a screen printing apparatus which has a simple design, yet maximizes efficiency by minimizing adjustment interruptions and maintenance downtime and maximizes screen printing precision, has surprisingly been discovered.

In one embodiment, a screen printing apparatus comprises: a substrate for receiving a sheet of material thereon; a support frame releasably coupled to a master frame for securing a print screen, the print screen configured to impart an imprint on the sheet of material; a plurality of uprights coupled to the support frame; and a plurality of servomechanisms coupled to the plurality of uprights to selectively position the print screen in respect of the substrate.

In another embodiment, a screen printing apparatus comprises: a substrate for receiving a sheet of material thereon; a support frame releasably coupled to a master frame for securing a print screen, the print screen configured to impart an imprint on the sheet of material; a plurality of uprights coupled to the support frame; and at least one servomechanism coupled to the uprights and contacting the support frame to selectively position the print screen in a substantially parallel position in respect of the substrate and a substantially angular position in respect of the substrate.

In a further embodiment, a method of screen printing a piece of material comprising the steps of: providing a screen printing apparatus comprising a substrate for receiving a sheet of material thereon, a support frame releasably coupled to a master frame for securing a print screen, the print screen configured to impart an imprint on the sheet of material, a plurality of uprights coupled to the support frame; and a plurality of servomechanisms coupled to the plurality of uprights to selectively position the print screen in respect of the substrate; selecting a position to displace the print screen from at least a first predetermined position, a second predetermined position, and a third predetermined position; activating the plurality of servomechanisms to position the print screen in one of the at least the first predetermined position, the second predetermined position, and the third predetermined position.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a top plan view of a screen printing apparatus according to an embodiment of the present invention;

FIG. 2 is a side perspective view of the screen printing apparatus illustrated in FIG. 1;

FIG. 3 is an enlarged fragmentary side perspective view of a portion of the the screen printing apparatus highlighted by circle 3 in FIG. 2, showing a servomechanism coupled thereto; and

FIG. 4 is a side perspective view of an opposing side of the screen printing apparatus illustrated in FIG. 2, showing a pair of servomechanisms according to an alternate embodiment of the present invention coupled thereto;

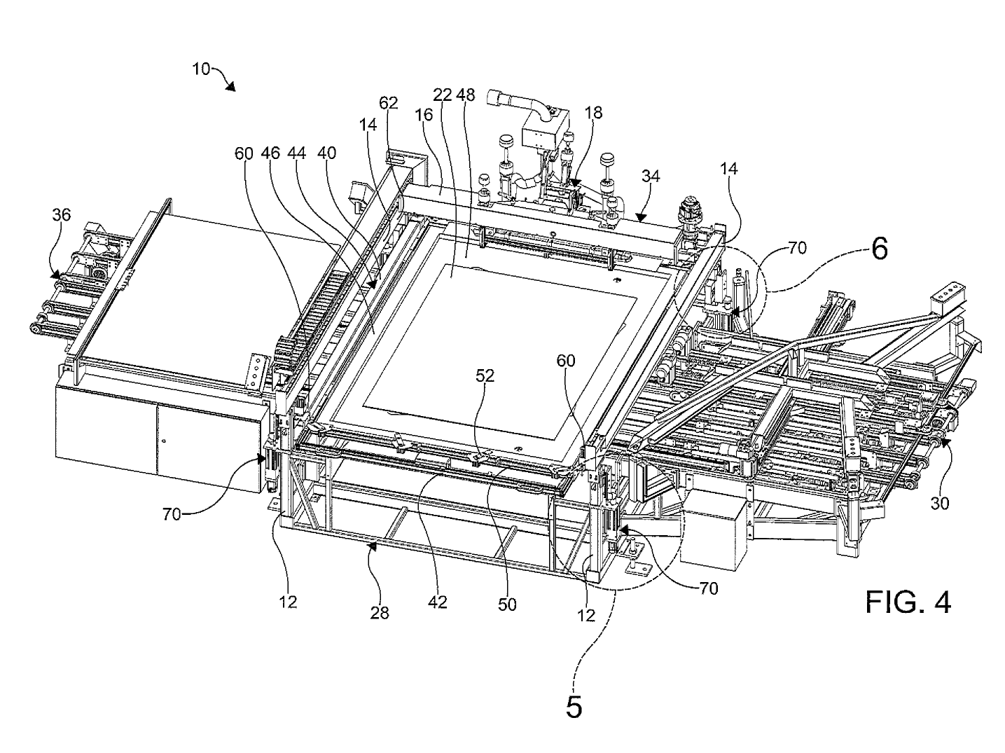

FIG. 5 is an enlarged fragmentary side perspective view of the screen printing apparatus highlighted by circle 5 in FIG. 4, showing a servomechanism coupled thereto;

FIG. 6 is a side perspective view of the servomechanism of the screen printing apparatus highlighted by circle 6 in FIG. 4, showing a positioning member of the screen printing apparatus according to an embodiment of the present invention.

FIG. 7 is a side perspective view of a servomechanism and a positioning member according to another embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

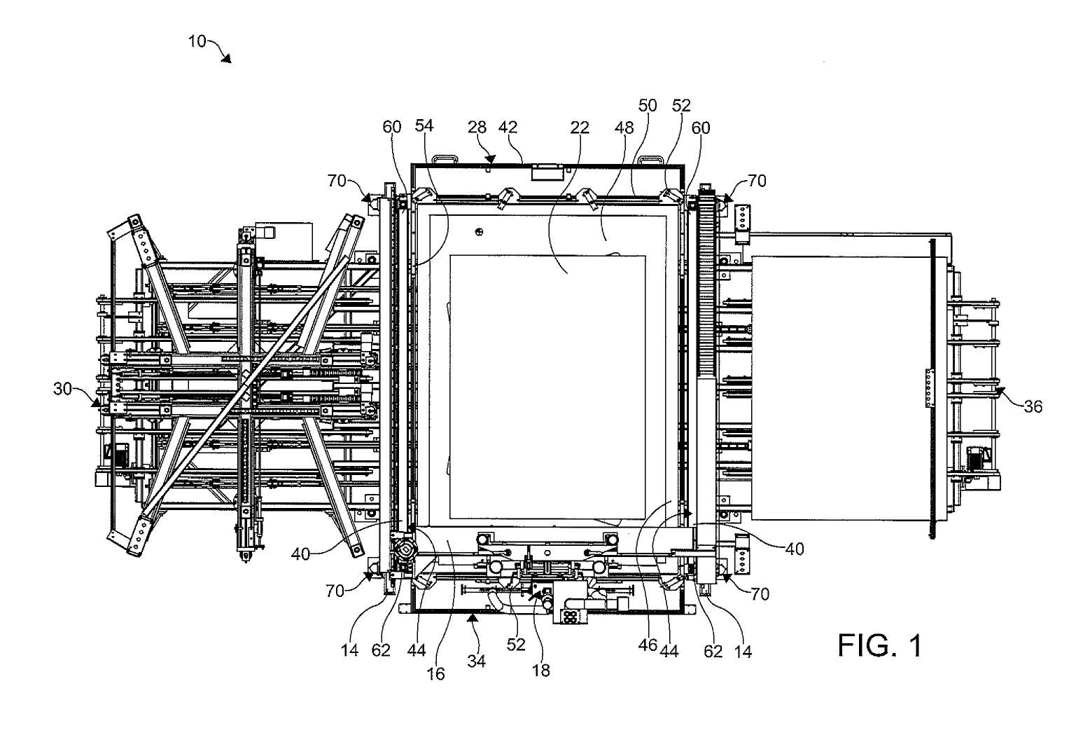

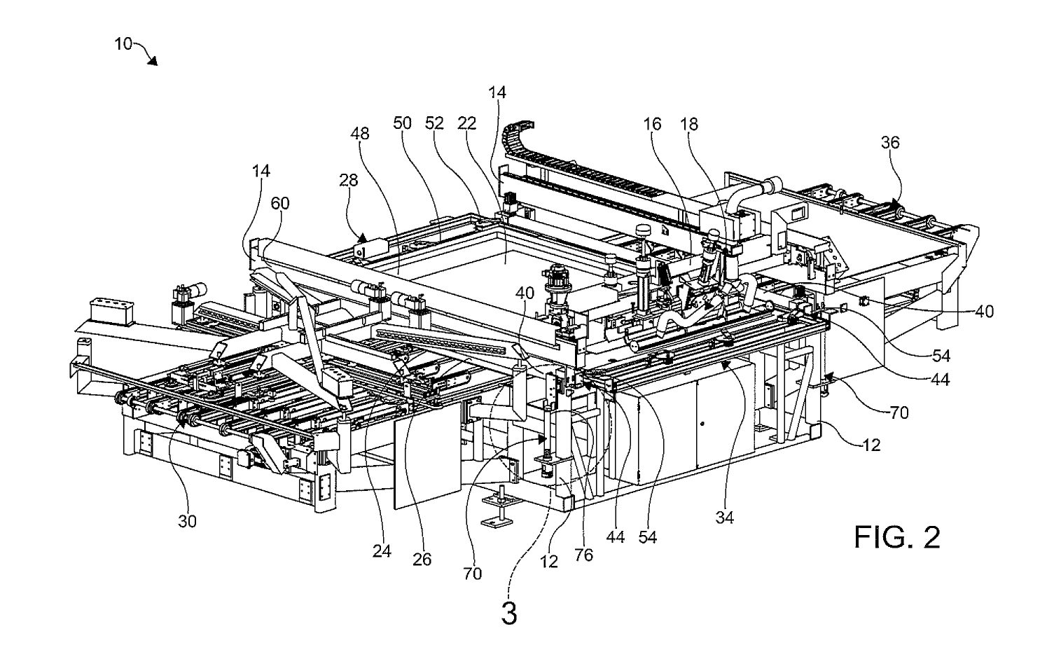

FIGS. 1-2 show a screen printing apparatus 10 according to an embodiment of the present invention. The apparatus 10 includes a plurality of uprights 12 supporting a pair of spaced apart fixed beams 14 supported by the uprights 12. The fixed beams 14 have a bridge 16 extending therebetween and slideably mounted thereon. The bridge 16 is slideable in a longitudinal direction in respect of the fixed beams 14. It is understood that the bridge 16 can be driven in the longitudinal direction by any means as desired such as a servomechanism, for example. The bridge 16 has an ink applicator mechanism 18 moveably attached thereto. The ink applicator mechanism 18 is at least moveable in a direction substantially perpendicular to a plane of a sheet of material 22 such as a pane of glass, for example, supported by the screen printing apparatus 10. Although glass is used herein as an example of the type of the sheet of material, it is understood that other sheets of material can be used such as wood, paper, metal, plastic, ceramics or the like. It is further understood that the sheet of material can have a flat, curved, or an uneven surface, cylindrical or arcuate shaped bends, or any other shape as desired. The ink applicator mechanism 18 is configured to distribute ink to the sheet of material 22. It is understood that the ink applicator mechanism 18 can include various applicator tools as needed such as, for example, a squeegee, a flood bar, a fill blade, or the like. The sheet of material 22 is supported by an underlying substrate 24 having a substantially planar surface 26. The orientation of the apparatus 10 is such that there is a front side 28 where an operator is positioned, a side 30 for a supplying of the sheet of material 22, a rear side 34, and a side 36 for an unloading the sheet of material 22.

The uprights 12 are coupled to a pair of spaced apart longitudinal displaceable members 40 of a support frame 44. Each of the members 40 can be positioned to move in a substantially vertical direction with respect to the surface 26 of the underlying substrate 24 supporting the sheet of material 22. A master frame 42 is coupled between the members 40. In certain embodiments, the master frame 42 is secured to the members 40 by pins (not shown) disposed on the members 40 received in corresponding holes (not shown) formed in the master frame 42. The master frame 42 receives and positions a frame 46 of a print screen 48 therein. The print screen 48 is configured to impart an imprint on the sheet of material 22. In certain embodiments, the frame 46 supporting the print screen 48 is secured in the master frame 42 by slidable cross-pieces 50 and a plurality of retainers 52 such as clamps, clips, fasteners, and the like, for example. Within the members 40, in certain embodiments, is housed a sliding carriage unit 54 which permits the master frame 42 to be displaceable along a longitudinal axis of the members 40. Accordingly, the master frame 42 can be positioned away from the underlying substrate 24 and the bridge 16 to maximize accessibility to the print screen 48 during a cleaning of the print screen 48. It is understood that any suitable means for permitting axial displacement of the master frame 42 along the longitudinal axis of the members 40 can be employed as desired.

As shown in FIGS. 1-2, a servomechanism 70 is disposed near opposing ends 60, 62 of each of the members 40 of the support frame 44. The servomechanisms 70 selectively position the support frame 44, the master frame 42, and hence the frame 46 of the print screen 48, in various positions in respect of the plane of the sheet of material 22 and with respect to a predetermined zero position of the apparatus 10. Each of the servomechanisms 70 can be separately controlled by a programmable control unit (not shown), or alternatively, any combination of the servomechanisms 70 can be synchronously controlled in combination by the programmable control unit. For example, each of the servomechanisms 70 can be synchronously controlled to cause the entire support frame 44, the entire master frame 42, and hence the entire frame 46 of the print screen 48 to move in the substantially vertical direction with respect to the surface 26 of the underlying substrate 24 so that the print screen 48 is substantially parallel to the underlying substrate 24. In another non-limiting example, the servomechanisms 70 coupled to one of the ends 60, 62 of each of the members 40 can be synchronously controlled to cause a side or an end of the support frame 44, a corresponding side or an end of the master frame 42, and hence a corresponding side or an end of the frame 46 of the print screen 48 to move in a substantially vertical direction with respect to the surface 26 of the underlying substrate 24 so the print screen 48 is disposed at an angle relative to the underlying substrate 24. In yet another non-limiting example, the servomechanisms 70 coupled to one of the ends 60, 62 of each of the members 40 can be synchronously controlled and the servomechanisms 70 coupled to another one of the ends 60, 62 of each of the members 40 can be synchronously controlled to cause the opposing sides or the ends of the support frame 44, the corresponding opposing sides or the ends of the master frame 42, and hence the corresponding opposing sides or the ends of the frame 46 of the print screen 48 to move in distinct linear directions with respect to the surface 26 of the underlying substrate 24 so the print screen is disposed at an angle relative to the underlying substrate. Because each of the servomechanisms 70 can be separately or synchronously controlled by the programmable control unit, the ends 60, 62 of the members 40 are not required to be mechanically coupled together by multiple drive systems in order to cause the support frame 44, the master frame 42, and hence the frame 46 of the print screen 48 to move as desired with respect to the surface 26 of the underlying substrate 24.

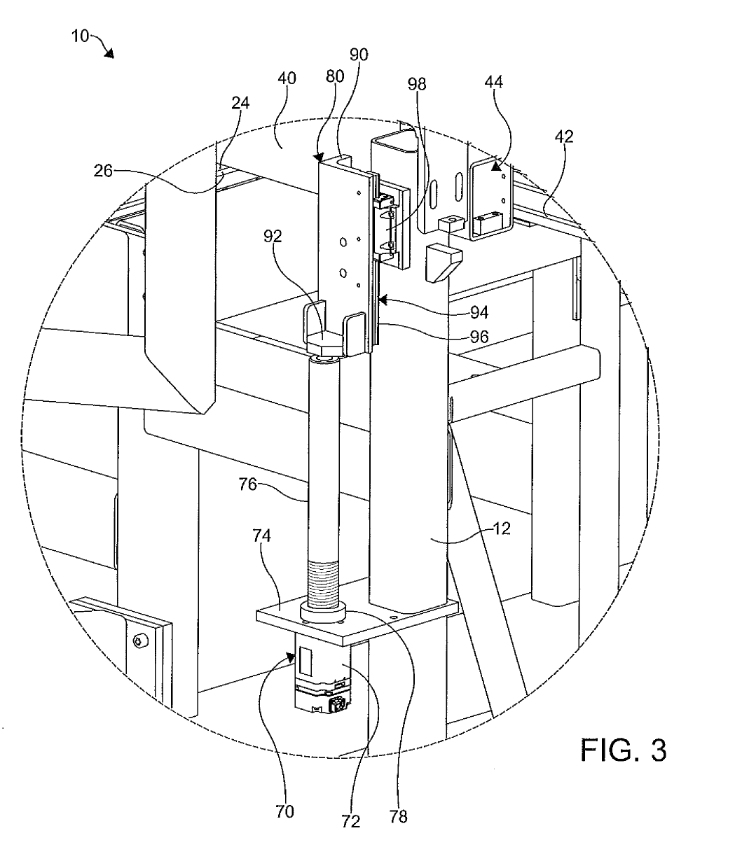

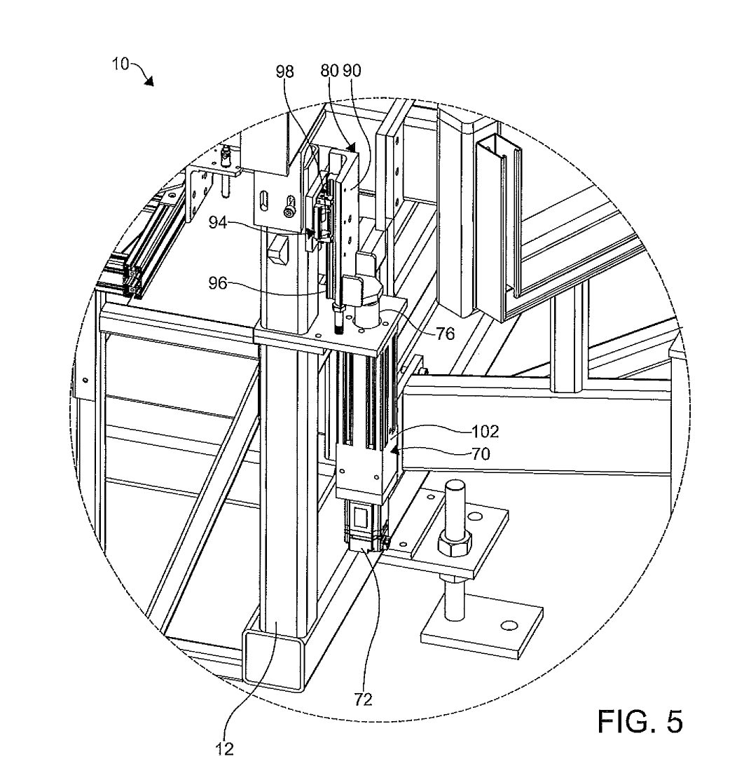

As shown in FIG. 3, each of the servomechanisms 70 includes a servomotor 72 and an output shaft 76 coupled thereto by a coupling member 78. The servomechanisms 70 are supported by a bracket 74 removeably mounted to the uprights 12 of the screen printing apparatus 10. It is understood that the servomechanism 70 can be secured to the uprights 12 by clamps, fasteners, plates, or other mounting devices as desired. The servomotor 72 is configured to position the output shaft 76 to a specific linear position through a coded signal sent to the servomotor 72 via an input line. It is understood that the output shaft 76 can be a ball screw, threaded shaft, or an unthreaded shaft configured to move linearly, for example. The servomechanisms 70 are disposed at a position on the uprights 12 such that at selected linear positions of the output shaft 76, the servomechanisms 70 are in mating contact with a positioning member 80 coupled to each opposing end 60, 62 of the members 40 of the support frame 44. The servomechanisms 70 cooperate with the positioning member 80 to position the support frame 44 and thereby position the master frame 42, and the print screen 48 in substantially parallel or substantially angular positions with respect to the surface 26 of the underlying substrate 24. In certain embodiments, the input line is in signal communication with the programmable control unit. As long as the coded signal exists on the input line, the servomotor 72 maintains the linear position of the output shaft 76, and as a result a position of the support frame 44, the master frame 42, and the print screen 48, is also maintained. As the coded signal changes, the servomotor 72 rotates. The rotation of the servomotor 72 causes the linear position of the output shaft 76 to change. In a non-limiting example, a rotary servomotor with a means to convert a specific angular position received by the coded signal to a linear position, such as a lead screw, can be employed if desired. Accordingly, at least a portion of the support frame 44, the master frame 42, and the print screen 48 is caused to move in at least one of the substantially vertical direction or the angular direction with respect to the surface 26 of the underlying substrate 24. It is understood that any suitable linear servomotor 72 can be employed as desired. In a non-limiting example of the invention, shown in FIG. 5, the servomotor 72 is coupled to a cylinder 102 that includes an output shaft 76 having a ball screw, for example.

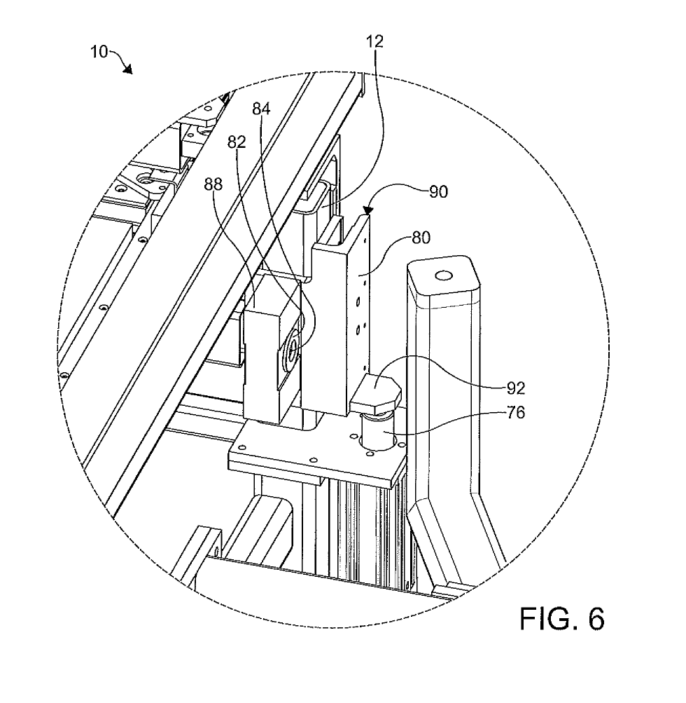

The positioning member 80 is coupled to the member 40 using any suitable means for coupling. In the embodiment shown in FIG. 6, a coupling member 82 received within a bushing 84 of the positioning member 80 is affixed to the member 40 by a plurality of fasteners (not shown). It is understood that the coupling member 82 of the positioning member 80 can be affixed to the member 40 by any means as desired such as fasteners, locking o-rings, and the like, for example. The bushing 84 permits a rotational movement of the coupling member 82 within the positioning member 80. In certain instances, the coupling member 82 is caused to rotate when each of the servomechanisms 70 is operated separately and the ends 60, 62 of the members 40 are moved to distinct positions such as during a peel-off phase of the operation, for example.

As shown in FIGS. 3, 5, and 6, the positioning member 80 is slidably coupled to the uprights 12 by a support system 94. The support system 94 includes a rail or track 96 disposed on the positioning member 80 and a stationary carriage 98 affixed to the upright 12. The support system 94 provides a guide for the positioning member 80, militating against undesired movement thereof such as a twisting, a rotational, or a lateral movement, for example. The positioning member 80 has a block portion 88, an L-shaped portion 90 affixed to the block portion 88 partially enclosing the upright 12, and a seat portion 92 affixed to the L-shaped portion and configured to cooperate with the output shaft 76 of the servomechanism 70 to position the support frame 44 as desired. However, it is understood that the positioning member 80 of the screen printing apparatus 10 can have any shape configured to cooperate with the servomechanism 70 to cause the support frame 44 to move as desired. For example, the positioning member 80 can have a substantially rectangular shape, a T-shape, or the positioning member 80 can be shaped to entirely enclose the upright. In another non-limiting example, the servomechanism 70 can be coupled to the upright such that the output shaft 76 directly cooperates with the member 40 to position the support frame 44.

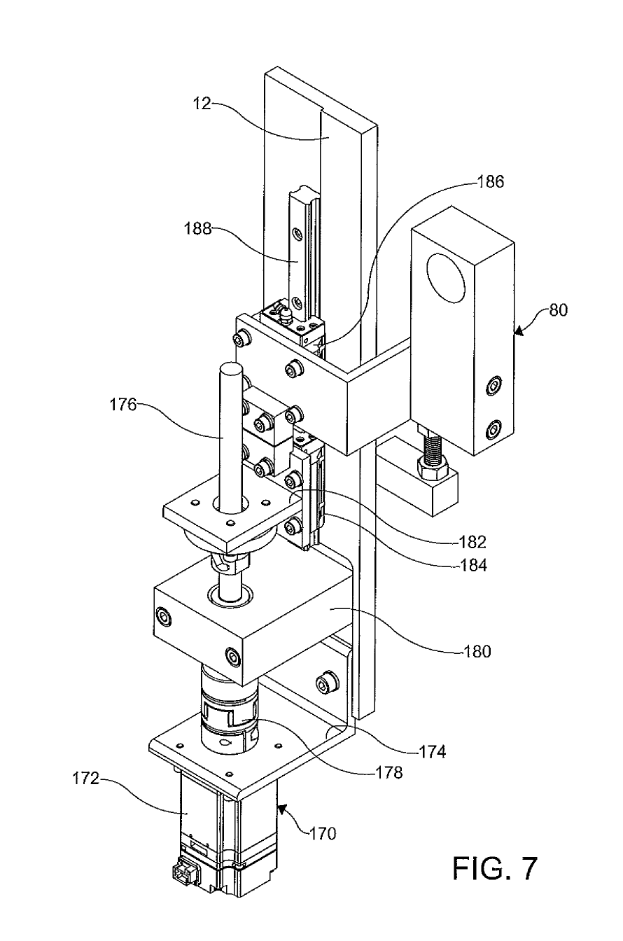

Another embodiment of the servomechanism 170 and positioning member 80 is shown in FIG. 7. The servomechanism 170 includes a servomotor 172 and an output shaft 176 coupled thereto by a coupling member 178. The servomechanisms 170 are supported by a bracket 174 removeably mounted to the uprights 12 of the screen printing apparatus 10. The output shaft 176 is coupled to a fixed guide block 180 configured to guide the output shaft 176 during linear positioning of the output shaft 176 and a linear guide block 182 configured to facilitate linear movement of the members 40 of the support frame 44. It is understood that the output shaft 176 can be a ball screw, threaded shaft, or an unthreaded shaft configured to move linearly, for example. The fixed guide block 180 can include rolling ring bearings, threaded followers, or roller bearings or any other similar mechanical devices for facilitating linear movement of a shaft, for example. The linear guide block 182 is coupled to a linear bearing 184. The linear bearing 184 is coupled to a track 188 disposed on the upright 12. As the output shaft 176 moves in a linear direction, the linear guide block 182 moves in a linear direction and thus, the linear bearing 184 moves in a linear direction.

The positioning member 80 of the screen printing apparatus 10 is coupled to a linear bearing 186 disposed on the track 188 adjacent the linear bearing 184 coupled to the linear guide block 182. At selected linear positions of the output shaft 76, the linear bearing 184 coupled to the linear guide block 182 is in mating contact with the linear bearing 186 coupled to the positioning member 80. At the selected linear positions of the output shaft 176, the linear bearing 184 coupled to the linear guide block 182 moves the linear bearing 186 coupled to the positioning member 80 in a linear direction hence moving the positioning member 80 and a portion of the members 40 of the support frame 44 in a substantially linear direction.

Each of servomechanisms 70, 170 can be employed to operate other drive mechanisms such as ball screws, gear rack drives, belt drives, and the like, for example, to move at least a portion of the support frame 44, the master frame 42, and the print screen 48 in the substantially vertical direction to at least one of the angular position or parallel position with respect to the surface 26 of the underlying substrate 24. Each of the servomechanisms 70, 170 can be controlled by the programmable control unit to be separately or synchronously controlled with other devices driven by a servomotor 72. In a non-limiting example, the servomechanisms 70, 170 coupled to one of the ends 60, 62 of each of the members 40 can be synchronously controlled with a servomotor driving the bridge 16 to cause the opposing sides or the ends of the support frame 44, the corresponding opposing sides or the ends of the master frame 42, and hence the corresponding opposing sides or the ends of the frame 46 of the print screen to move in distinct linear directions synchronously with a movement of the bridge 16.

During the operation of the screen printing apparatus 10, the print screen 48 is prepared according to predetermined requirements. For example, portions of the print screen 48 are blocked off in the negative image of the design to be printed in which the non-blocked portions of the print screen 48 are where the ink will appear on the sheet of material 22. The prepared print screen 48 is then mounted to the master frame 42 by sliding the cross-pieces 50 to abut the frame 46 and locking the print screen 48 in position with the retainers 52. The pins of the members 40 are then received in the holes of the master frame 42 to secure the master frame 42 to the support frame 44 in a fixed position on a plane substantially parallel to the surface 26 of the underlying substrate 24. It is understood other means of securing the master frame 42 to the support frame 44 can be employed as desired, Each of the servomechanisms 70 is then synchronously activated by the programmable control unit to raise the members 40 of the support frame 44, the master frame 42, and the entire print screen 48 in a substantially vertical first direction to a first predetermined distance away from the underlying substrate 24, permitting the sheet of material 22 to be received onto the surface 26 of the underlying substrate 24. The sheet of material 22 is then supplied by means of associated devices (not shown), arranging the sheet of material 22 on the surface 26 in a desired position.

The servomechanisms 70 are then synchronously activated by the programmable control unit to lower the members 40, the master frame 42, and the entire print screen 48 in a substantially vertical second direction to a second predetermined distance away from the underlying substrate 24, permitting a printing cycle to begin. In certain embodiments, the second predetermined distance is a pre-set printing position or “off contact” distance between the print screen 48 and the underlying substrate 24 during the printing stage. Thereafter, the apparatus 10 performs a printing cycle in a two-step procedure. A pool of printing ink (not shown) is pushed by the ink applicator mechanism 18 across the print screen 48 in a first direction toward one end of the print screen 48, in a so-called “flood stroke.” The ink applicator mechanism 18 is then drawn in an opposite second direction across the print screen 48 to force the ink through prescribed areas for making an imprint on the sheet of material 22, in a so-called “print stroke”.

For off-contact printing, an appreciable stretch of the print screen 48 is taken into consideration. Accordingly, the print screen 48 is peeled or lifted behind the ink applicator mechanism 18 synchrounsly as the ink applicator mechanism 18 is moved across the print screen 48 in the print stroke. Lifting the print screen 48 behind the ink applicator mechanism 18 during the print stroke permits the print screen 48 to be immediately separated from the sheet of material 22 after a passage of the ink applicator mechanism 18, militating against undesired smudges or other defects to the imprint on the sheet of the material 22. In certain embodiments, the portion of the print screen 48 behind the ink applicator mechanism 18 is immediately lifted by synchronously activating the pair of servomechanisms 70 located behind the ink applicator mechanism 18. The servomechanisms 70 located behind the ink applicator mechanism 18 cause one of the ends 60, 62 of the members 40, the corresponding side or end of the master frame 42, and the corresponding portion of the print screen 48 behind the ink applicator mechanism 18 to move in a direction away from the sheet of material 22, thereby maintaining a substantially constant angle between the print screen 48 and the ink applicator mechanism 18. Accordingly, as the ink applicator mechanism 18 is moved across the print screen 48 during the print stroke, the portion of the print screen 48 behind the ink applicator mechanism 18 continues to move in the direction away from the sheet of material 22 until the print stroke is completed. The servomechanisms 70 permit the print screen 48 to be separated from the sheet of material 22 in a controlled and relatively precise manner, further militating against undesired smudges or other defects to the imprint on the sheet of material 22. It is understood that successive flood and print strokes can be conducted as desired.

Upon completion of the printing cycle, each of the servomechanisms 70 is synchronously activated by the programmable control unit to raise the members 40, the master frame 42, and the entire print screen 48 in the substantially vertical first direction to the first predetermined distance away from the underlying substrate 24, permitting the imprinted sheet of material 22 to be removed and a fresh sheet of material 22 to be received onto the surface 26 of the underlying substrate 24 for printing. The printing cycle described hereinabove can be repeated for as many sheets of material 22 as desired. It is understood that the removal of the imprinted sheet of material 22 and replacement with the fresh sheet of material 22 is performed in a conventional manner synchronized with the flood and print strokes of the printing cycle. It is understood that the servomechanisms 70 coupled to one of the ends 60, 62 of each of the members 40 can be separately or synchronously controlled to cause a side or end of the support frame 44, a corresponding side or end of the master frame, and hence a corresponding side or end of the frame 46 of the print screen 48 to move in a direction to facilitate printing on a sheet of material 22 with an uneven surface. It is also understood that the servomechanisms 70 can be separately or synchronously controlled for other purposes associated with operation of the apparatus 10. For example, the servomechanisms 70 coupled to one of the ends 60, 62 of each of the members 40 can be synchronously controlled to cause a side or end of the support frame 44, a corresponding side or end of the master frame 42, and hence a corresponding side or end of the frame 46 of the print screen 48 to move in the direction away from the sheet of material 22 for cleaning of a portion of the print screen 48 without extraction of the print screen 48 from the apparatus 10.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A screen printing apparatus comprising:
a substrate for receiving a sheet of material thereon;
a support frame releasably coupled to a master frame for securing a print screen, the print screen configured to impart an imprint on the sheet of material;
a plurality of uprights coupled to the support frame; and
a plurality of servomechanisms coupled to the plurality of uprights to selectively position the print screen in respect of the substrate.

2. The screen printing apparatus of claim 1, wherein each of the plurality of servomechanisms includes a servomotor having an output shaft coupled to the servomotor, the output shaft moveable in a substantially linear direction.

3. The screen printing apparatus of claim 1, wherein the screen printing apparatus includes a plurality of positioning members coupled to the support frame and cooperating with the plurality of servomechanisms to selectively position the support frame.

4. screen printing apparatus of claim 1, wherein the plurality of servomechanisms permit the print screen to move to a position substantially parallel in respect to the sheet of material and to a position angular in respect to the sheet of material.

5. The screen printing apparatus of claim 1, wherein the support frame includes a pair of spaced apart longitudinal displaceable members and each of the pair of spaced apart longitudinal displaceable members has opposing ends.

6. The screen printing apparatus of claim 5, wherein the plurality of servomechanisms is disposed near the opposing ends of each of the pair of spaced apart longitudinal displaceable members.

7. The screen printing apparatus of claim 6, wherein at least two of the plurality of servomechanisms cooperate with the spaced apart longitudinal displaceable members to move the print screen to an angular position in respect of the substrate.

8. screen printing apparatus of claim 6, wherein each of the plurality of servomechanisms cooperates with the spaced apart longitudinal displaceable members to move the print screen in a substantially vertical direction with respect to the substrate to a position substantially parallel with respect to the substrate.

9. The screen printing apparatus of claim 1, wherein each of the plurality of servomechanisms is configured to be separately or synchronously controlled to selectively position the print screen, and each of the plurality of servomechanisms is configured to be controlled separately or synchronously with a movement of a bridge coupled to the screen printing apparatus.

10. A screen printing apparatus comprising:
a substrate for receiving a sheet of material thereon;
a support frame releasably coupled to a master frame for securing a print screen, the print screen configured to impart an imprint on the sheet of material;
a plurality of uprights coupled to the support frame; and
at least one servomechanism coupled to the uprights and contacting the support frame to selectively position the print screen in a substantially parallel position in respect of the substrate and a substantially angular position in respect of the substrate.

11. The screen printing apparatus of claim 10, wherein the at least one servomechanism has a servomotor and an output shaft coupled to the servomotor, the output shaft moveable in a substantially linear direction.

12. The screen printing apparatus of claim 10, wherein the support frame includes a pair of spaced apart longitudinal displaceable members and each of the pair of longitudinal displaceable members has opposing ends.

13. The screen printing apparatus of claim 12, further comprising at least four servomechanisms, each of the at least four servomechanisms disposed near each of the opposing ends of the pair of longitudinal displaceable members.

14. The screen printing apparatus of claim 13, wherein each of the servomechanisms includes a servomotor and at least two of the servomotors cooperate with the spaced apart longitudinal displaceable members to synchronously move the print screen to an angular position in respect of the substrate during a print stroke operation of the screen printing apparatus and each of the at least four servomechanisms cooperate with the spaced apart longitudinal displaceable members to synchronously move the print screen in a substantially vertical direction with respect to the substrate to a position substantially parallel with respect to the substrate during a material placement operation of the screen printing apparatus, and each of the at least four servomechanisms is configured to be controlled separately or synchronously with a movement of a bridge coupled to the screen printing apparatus.

15. A method of screen printing a piece of material comprising the steps of:
providing a screen printing apparatus comprising a substrate for receiving a sheet of material thereon, a support frame releasably coupled to a master frame for securing a print screen, the print screen configured to impart an imprint on the sheet of material, a plurality of uprights coupled to the support frame; and a plurality of servomechanisms coupled to the plurality of uprights to selectively position the print screen in respect of the substrate;
selecting a position to displace the print screen from at least a first predetermined position, a second predetermined position, and a third predetermined position;
activating the plurality of servomechanisms to position the print screen in one of the at least the first predetermined position, the second predetermined position, and the third predetermined position.

16. The method of screen printing of claim 15, further comprising the step of activating the plurality of servomechanisms synchronously to raise the print screen in a substantially vertical first direction with respect to the substrate to the first predetermined position.

17. The method of screen printing of claim 15, further comprising the step of activating the plurality of servomechanisms synchronously to lower the print screen in a substantially vertical second direction with respect to the substrate to the second predetermined position.

18. The method of screen printing of claim 15, further comprising the step of activating at least one of the plurality of servomechanisms to move the print screen to an angular position with respect to the substrate to the third predetermined position.

19. The method of screen printing of claim 18, further comprising the step of activating the at least one of the plurality of servomechanisms during a print stroke operation of the screen printing apparatus.

20. The method of screen printing of claim 15, wherein the support frame includes a pair of spaced apart longitudinal displaceable members having opposing ends, wherein each of the plurality of servomechanisms is disposed near each of the opposing ends of each of the spaced apart longitudinal displaceable members.
